(19) United States
(12) Patent Application Publication
(10) Pub. No.: US 2020/0386524 A1
(43) Pub. Date: Dec. 10, 2020

(54) SHOCK-ABSORBING SEAT WITH WALL-MOUNTED DAMPERS

(71) Applicants: Francois BUDER, Bonn (DE); Rene NEULING, Hennef (DE); Michael INDEN, Kerpen (DE)

(72) Inventors: Francois BUDER, Bonn (DE); Rene NEULING, Hennef (DE); Michael INDEN, Kerpen (DE)

(21) Appl. No.: 16/605,087

(22) PCT Filed: Apr. 13, 2018
(86) PCT No.: PCT/EP2018/059604

§ 371 Date: Oct. 14, 2019

(30) Foreign Application Priority Data
Apr. 13, 2017 (DE) 10 2017 108 074.0

(51) Int. Cl. F41H 7/04; B60R 22/28; B60N 2/42

(52) U.S. Cl. CPC F41H 7/046; B60R 2022/283; B60N 2/42; B60R 22/28

(57) ABSTRACT

The invention relates to a damping member (1), comprising at least two engagement points (2), the damping member (1) having an absorption means that acts elastically, wherein fastening elements (3) are arranged on the damping member (1) and wherein the damping member (1) is designed to be deformable.

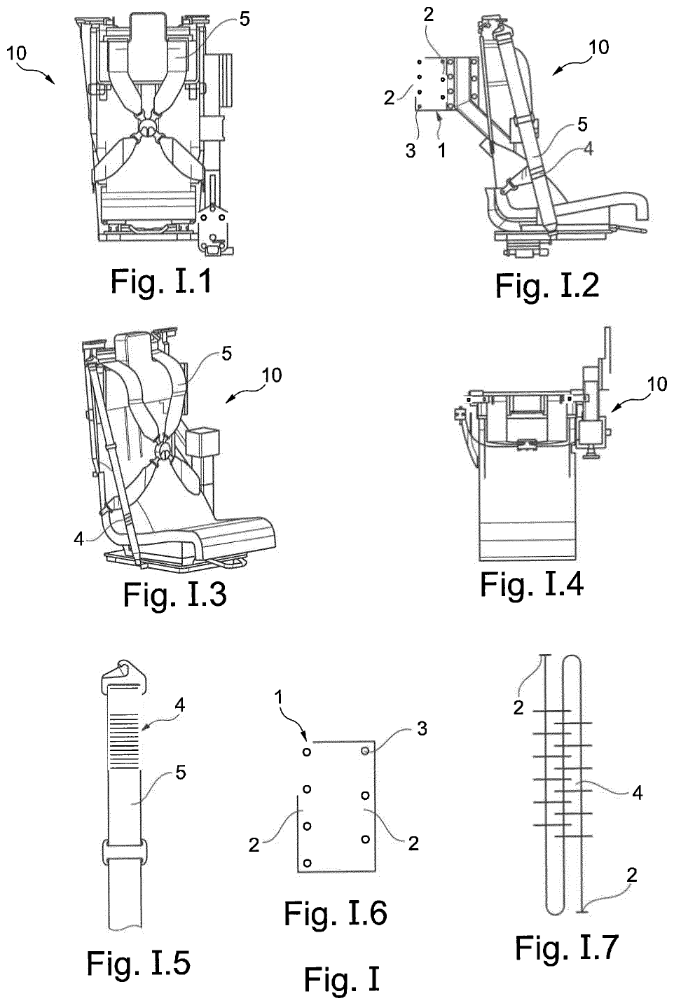

The invention relates to a damping member and also to a seat for a land vehicle and that has at least one damping member according to the invention.

Seats for land vehicles, in particular for military purposes and that have damping members in order to absorb shocks acting on the vehicle from the outside and therefore provide protection to the occupants sitting on these seats are known. Shocks acting on the vehicle from the outside are generally impacts from explosive materials, as are used for example in mines over which the vehicle drives.

DE 10 2008 053 152 discloses a deformation element for protecting a device, in particular a footrest plate in an, in particular, military vehicle where the deformation element is substantially U-shaped.

The object of the invention is to provide a damping member that has improved shock absorption in comparison to conventional damping members. Another object of the invention is to provide a seat for a vehicle that protects the person using it from external impacts.

The invention proposes a damping member that has two attachment points in order to introduce forces that occur in a pulsed manner into the damping member.

The damping member further has fastening elements by which the damping member can be fastened. The fastening points are preferably arranged at the attachment points, so that the action of force on the damping member can take place through the fastening elements.

The damping member according to the invention further has a force absorber that is capable of absorbing introduced forces and in this way can damp the actions of force that occur in a pulsed manner.

The force absorber proposed here is an elastic substance that returns to its initial position after action of force. According to the invention, the elastic substance has a force limit up to which the substance deforms only elastically. If this force limit is exceeded, the force absorber is plastically deformed. In this case, the deformation also absorbs the exerted force and converts it into deformation work.

According to the invention, the force absorber is integrated into the damping member or the material of the damping member itself is designed as force absorber.

The damping member is preferably designed from a wall holder. In this case, the damping member is between the element that is to be damped and a wall. In this case, simple mounting on the wall and the element that is to be damped is rendered possible by the fastening elements.

In a particular embodiment, the damping member is designed as a strap. In this case, the strap acts as a force absorber owing to its physical properties. To this end, the strap is preferably provided with an elasticity and/or is of multilayered design. Therefore, the material of the strap itself is the force absorber.

Similarly, the force absorber can also consist of seams that connect at least two layers of the straps to one another. The possible deformation work of the force absorber takes effect here owing to the separation of the seams in the event of action of force. Therefore, the seams are the force absorber. These seams can be integrated into the strap at least in regions.

The seams of the strap are preferably arranged so as to run parallel to one another and transversely in relation to the strap. This creates a number of seams that run parallel to one another and that run transversely in relation to the strap at a spacing from one another. In this case, the spacings can be of identical or different design for all seams. These seams are provided on a strap at least in regions.

In this case, a strap according to the invention can be connected in an articulated manner to a seat and/or to the chassis of a vehicle, in particular to the wall of the vehicle, by its attachment points. To this end, the strap can be arranged such that a person on the seat is protected or moving parts of the seat are damped. For example, the strap can be connected in an articulated manner to the sitting surface and the backrest of the seat in order to damp a foldable sitting surface. In the event of an exemplary action of force from below, the force is then exerted on the seat. If the seat has a moving or foldable sitting surface, an upward movement of the sitting surface can be damped by the inertia of the person on the seat when a damping member according to the invention is designed as a strap and is connected in an articulated manner to the sitting surface and the seat backrest. Similarly, connection in an articulated manner to the sitting surface and the chassis is conceivable for this purpose.

The damping members are designed such that they can be used in a vehicle in order to cushion a vehicle seat against impact forces that are exerted on the seat. To this end, it is proposed to arrange at least one damping member according to the invention on the seat of the vehicle.

The seat can be damped by at least one damping member being arranged between the seat and the vehicle wall. Similarly, the seat can also be equipped with corresponding straps. A combination of a strap and a wall holder is likewise possible.

According to the invention, the damping member consists of an elastically deformable material that is of plate-like design. The element that is to be damped, for example a seat, is arranged and fastened at a suitable point, for example on a vehicle, by this plate-like damping member.

In this case, the material properties are selected such that the plate-like damping member does not deform in the event of normal loading of the seat and in the event of normal stress during operation of the vehicle. This also applies in the event of fluctuations in the temperature, the atmospheric humidity and comparable environmental parameters of the vehicle.

The material of the plate-like damping member allows this region to be deformed and the energy of the impact to be reduced owing to the deformation, in order to protect the person sitting on the seat, only when there is an impact on the vehicle from the outside and therefore a specific force limit is exceeded. The plate-like damping member can have corresponding fastening elements, such as bores, brackets or the like for example, so that the seat can be arranged and fastened on the vehicle by the damping member.

As an alternative, the damping member is integrated into a strap, for example by which the person sitting on the seat can strap in. Provision is made here for at least two layers of the strap material to be arranged substantially congruently one on the other in the region in which the strap forms the damping member.

The above-described damping members can, of course, also be used in combination with one another for an element that is to be damped, for example a seat. The wall-mounted damping member and/or the damping member that is integrated into the strap can then be used for this purpose.

A plurality of seam lines that connect the two layers of strap material, which are arranged substantially so as to extensively cover one another, to one another are made transversely in relation to the extent of the strap at spacings from one another.

Moreover, the strap is usually connected first to the seat and second to the chassis or to the seat once again. However, the strap can also be connected to a wall.

The plurality of seam lines that are parallel to one another and one behind the other in the longitudinal extent of the strap create a kind of predetermined tear point since the seams tear in succession as a consequence of the impact from the outside and in this way reduce the energy of the impact. During normal operation of the vehicle, this plurality of seam lines that are parallel to one another are dimensioned such that they do not tear up to a maximum loading with which the seat may be loaded.

Further features of the present invention are shown in the figures, in which:

FIG. I shows a seat according to the invention having damping members and a rear-side suspension arrangement;

FIG. I.1 is a front view of the seat;

FIG. I.2 is a side view of the seat;

FIG. I.3 is a perspective view of the seat;

FIG. I.4 is a top view of the seat;

FIG. I.5 shows a damping member according to the invention in a strap;

FIG. I.6 shows a damping member according to the invention in the form of a wall suspension arrangement;

FIG. I.7 shows a seam arrangement of a damping member according to the invention in the form of a strap.

A damping member 1 that has two attachment points 2 is provided in FIG. I. Fastening elements 3 are at the attachment points 2 on each side of the damping member 1. A force absorber that damps the damping member 1 is located between the attachment points.

To this end, the force absorber can be designed as material of the damping member 1. However, it could also be integrated into the damping member 1.

The damping member 1 and the force absorber have a force limit up to which the damping member deforms elastically. Thus, in the event of action of force, the damping is achieved by this elastic behavior. If the exerted force exceeds the elastic limit, plastic deformation of the damping member 1 takes place. In this case, at least a portion of the exerted force is converted into plastic deformation of the damping member.

A seat 10 is connected to a wall of a vehicle by the fastening elements 3 that are on the damping member 1.

If there is an impact on the vehicle from the outside, the damping member 1 according to the invention renders possible absorption of the energy of the impact both owing to its elasticity and also owing to a possible plastic deformation of the damping member 1.

Plastic deformation is realized by the two longitudinal axes of the fastening elements 3 being sheared and this shearing having an elastic action up to a force limit and causing the deformation of the damping member 1 above the force limit.

The elastic and also the plastic deformation serve to reduce the deformation energy and therefore considerably attenuate the impact acting from the outside, so that the person sitting on the seat 10 is very well protected against this external influence.

In a further refinement, the damping member 1 is integrated into a strap 5 with which the person sitting on the seat 10 can strap in. Provision is made here for two layers of the strap material to be arranged substantially congruently one on the other in the region in which the strap 5 forms the damping member 1.

In this case, the strap 5 can be fastened to the seat, to the wall of the vehicle, to the chassis of the vehicle or in combination of the above.

A plurality of seam lines that connect the two layers of strap material, which are arranged substantially so as to fully cover one another, to one another are made transversely of the strap 5 at spacings from one another. Moreover, the strap 5 is usually connected first to the seat 10 and second to the chassis 11 or to the seat once again. To this end, the fastenings of the straps 5 form the fastening elements 3 of the damping member 1 and the ends of the strap 5 form the attachment points 2.

The plurality of seam lines that are parallel to one another and one after the other in the longitudinal extent of the strap 5 create a kind of predetermined tear point since the seams tear in succession as a consequence of the impact from the outside and in this way reduce the energy of the impact. During normal operation of the vehicle, this plurality of seam lines that are parallel to one another are dimensioned such that they do not tear in the normal case up to a maximum load with which the seat 10 may be loaded.

FIG. I shows a seat 10 of a vehicle, which seat is connected to the seat 10 by the damping member 1 by fastening elements 3 or the like. Second, the damping member 1 is likewise connected to a wall, not illustrated, of a vehicle by fastening elements or the like.

The illustrated seat 10 is also equipped with the damping member 1 that is integrated in the strap 5.

FIG. I.7 shows a possible seam arrangement for a damping member 1 according to the invention in the form of a strap 5. The seams that run parallel to one another and transversely of the strap 5 connect two layers of the strap 5 here. The strap 5 itself is multilayered in the region of the seams. This can be embodied by loops that the strap 5 forms in the region of the seams, but the strap 5 can also form the multilayered region by a plurality of strap pieces being laid one over the other in an overlapping manner.

In the event of action of force on the strap at the attachment points 2, a shear force is then exerted on the seams that can be separated as a result and implement the damping of the damping member 1. As shown, the seams can each connect two layers, but they can also be continuous through all layers. In this case, the different seams can be formed from different materials with different tearing behavior.

FIGS. I.2 and I.3 show a particularly preferred arrangement of the damping members 1 that are designed as the strap 5. In this case, the strap 5 is anchored on the seat 10 by its attachment points 2, and one end of the strap 5 is anchored to the backrest of the seat and the other end of the strap 5 is anchored to the seat 10. As a result, the seat 10 can be damped in the event of an action of force on the vehicle if the sitting surface of the seat 10 is of movable, for example foldable, design.

All the figures show that both the damping member 1 without the strap and the damping member 1 that is integrated into the strap 5 are used. The protective effect is considerably increased as a result. Second, it is also conceivable for only the damping member 1 without the strap or only the damping member 1 that is integrated into the strap 5 to be able to be used in the embodiments of the seat 10 shown. The combination can also be considered.

The invention is not restricted to the above-described features. Rather, further refinements are possible. For example, an additional absorption element can be associated with the absorption element in order to increase the damping. Plug connections at the attachment points and/or fastening elements are likewise possible in order to make possible easy replacement of the damping members. Finally, the use of a plurality of damping members in parallel or in series would be possible in order to adjust the damping in accordance with the intended use.

LIST OF REFERENCE SIGNS

| | |
|---|---|
| 1 | Damping member |
| 2 | Attachment point |
| 3 | Fastening element |
| 4 | Seam |
| 5 | Strap |
| 10 | Seat |

1. In a damping member that has at least two attachment points, wherein
the damping member has a force absorber that has an elastic action,
fastening elements are on the damping member and the damping member is of deformable design.

2. The damping member according to claim 1, wherein the damping member is deformed plastically only starting from a certain exerted force limit and is not deformed plastically below this force limit.

3. The damping member according to claim 1, wherein the force absorber is designed as material of the damping member.

4. The damping member according to claim 1, wherein the damping member is integrated into at least one strap.

5. The damping member according to claim 4, wherein the strap is fastened to the wall of a vehicle and/or to a vehicle seat at the attachment points.

6. The damping member according to claim 1, wherein the fastening elements are designed for mounting on walls.

7. The damping member according to claim 1, wherein the damping member deforms elastically up to a maximum force, without plastic deformation of the damping member.

8. The damping member according to claim 7, wherein the damping member is deformed plastically starting from the maximum force.

9. The damping member according to claim 1, wherein the force absorber consists of at least two layers that lie one on the other.

10. The damping member according to claim 1, wherein the damping member has seams that cause the plastic deformation of the damping member by tearing.

11. The damping member according to claim 1, wherein the fastening elements are at the attachment points.

12. A seat for a land vehicle, wherein the seat comprises at least one damping member according to claim 1.

13. The seat according to claim 12, wherein the damping member is between the seat and a wall of the land vehicle.

14. The seat according to claim 12, wherein the seat comprises at least one strap and at least one damping member is integrated into the strap.
